(19) United States
(12) Patent Application Publication
(10) Pub. No.: US 2007/0226299 A1
(43) Pub. Date: Sep. 27, 2007

(54) Method and system for providing an instant messaging quorum monitoring service

(75) Inventors: Shmuel Shaffer, Palo Alto, CA (US); Labhesh Patel, San Francisco, CA (US); Mukul Jain, Santa Jose, CA (US); Denise G. Caballero-McCann, Raleigh, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/389,456

(22) Filed: Mar. 24, 2006

(51) Int. Cl. G06F 15/16

(52) U.S. Cl. 709/206

(57) ABSTRACT

A method for providing an instant messaging quorum monitoring service includes receiving a request from a first user to monitor instant messaging availability of a first number of users comprising at least one user who is currently unavailable. The method also includes receiving at least one quorum parameter for an instant messaging chat session. The method also includes monitoring the instant messaging availability of the first number of users and determining that the at least one quorum parameter for the instant messaging chat session is satisfied by the instant messaging availability of a second number of users of the first number of users. The second number of users comprises available users. The method also includes notifying the first user that the at least one quorum parameter for the instant messaging chat session is satisfied.

### TECHNICAL FIELD OF THE INVENTION

This invention relates in general to communication systems and, more particularly, to a method and system for providing an instant messaging quorum monitoring service.

### BACKGROUND OF THE INVENTION

The field of communications has become increasingly important in today's society. In particular, the ability to quickly and effectively interact with others (through any suitable communications media) presents a significant obstacle for component manufacturers, system designers, and network operators. This obstacle is made even more difficult due to the plethora of diverse communication technologies (e.g. instant messaging, cellular communications, simple voice sessions, etc.) that exist in the current marketplace. The problem is further exacerbated by the need to be able to communicate with several different people at the same time. Trying to coordinate an impromptu meeting between several different people can be difficult.

Instant messaging (IM) systems are gaining acceptance as a means for real time communication. Typically, a person may communicate in multiple instant messaging sessions at the same time. Some existing systems allow users to mark themselves as busy or unavailable. Additionally, an IM system provides users attempting to initiate IM sessions with the ability to be notified when someone they want to communicate with logs into the IM system or is no longer busy and thus becomes available for an IM chat.

### SUMMARY OF THE INVENTION

The present invention provides a method and system for providing an instant messaging quorum monitoring service that substantially eliminates or reduces disadvantages and problems associated with previous systems and methods.

In accordance with a particular embodiment of the present invention, a method for providing an instant messaging quorum monitoring service includes receiving a request from a first user to monitor instant messaging availability of a first number of users comprising at least one user who is currently unavailable. The method also includes receiving at least one quorum parameter for an instant messaging chat session. The method also includes monitoring the instant messaging availability of the first number of users and determining that the at least one quorum parameter for the instant messaging chat session is satisfied by the instant messaging availability of a second number of users of the first number of users. The second number of users comprises available users. The method also includes notifying the first user that the at least one quorum parameter for the instant messaging chat session is satisfied.

The method may also include initiating an instant messaging chat session between the first user and the available users. The method may also include inviting available users to participate in an instant messaging chat session with the first user. The method may also include receiving a topic for the instant messaging chat session from the first user and notifying the available users of the topic.

In some instances the at least one quorum parameter for the instant messaging chat session may include a designation of a third number of users of the first number of users as required attendees for the instant messaging chat session. Where the method includes determining that the at least one quorum parameter for the instant messaging chat session is satisfied by the instant messaging availability of the second number of users of the first number of users the method may also include determining that the required attendees for the instant messaging chat session are available via instant messaging.

The method may also include receiving a designation of a fourth number of users of the first number of users as desired attendees for the instant messaging chat session. The method may also include determining that at least one of the desired attendees is available via instant messaging and inviting the at least one desired attendee to participate in the instant messaging chat session.

Where the method includes determining that the at least one quorum parameter for the instant messaging chat session is satisfied by the instant messaging availability of a second number of users of the first number of users the method may include determining that each of the second number of users is currently participating in less than a fifth number of instant messaging chat sessions. Furthermore, to determine that each of the second number of users is currently participating in less than a fifth number of instant messaging chat sessions the method may include determining that each of the second number of users has sent less than a sixth number of instant messaging communications within a first period of time.

In accordance with another embodiment, a system for providing an instant messaging quorum monitoring service includes an interface operable to receive a request from a first user to monitor instant messaging availability of a first number of users comprising at least one user who is currently unavailable. The interface also is operable to receive at least one quorum parameter for an instant messaging chat session. The system also includes a processor coupled to the interface and operable to monitor the instant messaging availability of the first number of users. The processor is also operable to determine that the at least one quorum parameter for the instant messaging chat session is satisfied by the instant messaging availability of a second number of users of the first number of users. The second number of users comprises available users. The processor is also operable to notify the first user that the at least one quorum parameter for the instant messaging chat session is satisfied.

Technical advantages of particular embodiments include enabling a first user to monitor the IM availability of particular users to determine when a quorum of users is available. Accordingly, the first user may be notified when the quorum of users becomes available. Particular embodiments may allow the first user to specify how many of the users she wants to be available before starting an IM session. Once the specified number of users is available the IM session may begin. Accordingly, the first user saves time by avoiding the need to select the particular users a second time, after the specified number of users is available, to start the IM session. Particular embodiments may allow the first user to specify which users she requires to be available, and which users she desires to be available. Once the required users are available the IM session can begin and any desired users that are also currently available or become available during the IM session may be invited to or included in the IM session. Accordingly, an IM session with a large number of desired users may start sooner by only waiting for required users before starting the IM session.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system including a plurality of endpoints operable to communicate among each other and a plurality of instant messaging servers, in accordance with a particular embodiment of the present invention;

FIG. 2 illustrates the operation of an instant messaging server of FIG. 1 in more detail, illustrating aspects of the present invention; and

FIG. 3 illustrates a method for providing an instant messaging quorum monitoring service, in accordance with an embodiment of the present invention.

### DETAILED DESCRIPTION OF THE INVENTION

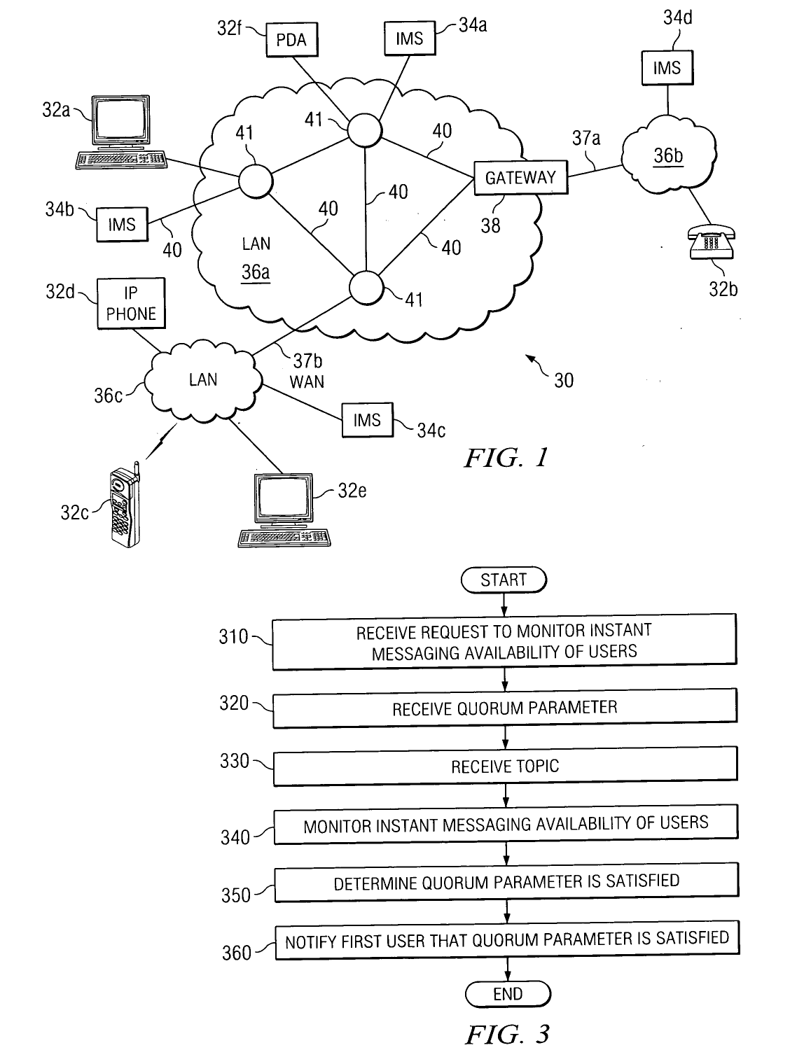

FIG. 1 illustrates a communication system 30 including a plurality of endpoints 32a-32f having the ability to communicate with each other and/or IM servers (IMSs) 34a-34d. At least some of endpoints 32a-32f have the ability to establish an IM communication session with other users, using one or more of communication networks 36a-36c. IMSs 34a-34d facilitate IM communications, such as the communication of text messages in almost real time, between endpoints 32a-32f. IM allows users to form lists of people with whom they wish to communicate, such as a “buddy list.” Typically, users may communicate with anyone on their buddy list who is presently logged-in and available. IMSs 34a-34d provide numerous different services such as the registration, authentication and tracking of IM users, the processing of messages, such as text messages between endpoints 32a-32f, and providing the status of other users, such as those on a user's buddy list.

In particular embodiments IMSs 34a-34d facilitate conferences using IM by monitoring the IM availability of multiple users to determine when a quorum of users is available for IM communication. Different embodiments may handle the detection of a quorum of available users differently. For example, some embodiments may notify the user who invoked the quorum monitoring service that a quorum has been detected by presenting the user with a message notifying her that the quorum of users are currently available. Some embodiments may similarly notify the available users that a quorum has been detected. In particular embodiments, the notice may be an invitation that includes, for example, a softkey that allows the user to join the IM session. Some embodiments may notify the available users that a quorum has been detected by initiating the IM session between the available users (including the user who initially invoked the quorum monitoring service). Some embodiments may provide the available users with the topic of the IM session. Some embodiments may invite users to a conference that has already begun where the user initially was not available when the conference begun but is now currently available.

In the illustrated embodiment, communication network 36a is a local area network (LAN) that enables users to communicate messages between a plurality of endpoints 32a-32f and IMSs 34a-34d distributed across multiple cities and geographic regions. Communication network 36a also provides a means for endpoints 32a-32f and IMSs 34a-34d to communicate control and status signals. Communication network 36b is a public switched telephone network (PSTN) and couples endpoint 32b and IMS 34d with communication network 36a through gateway 38. Communication network 36c is another LAN, which couples endpoints 32c, 32d and 32e and IMS 34c with communication network 36a. Accordingly, users of endpoints 32a-32f may establish communication sessions between and among each other, and also endpoints 32a-32f, IMSs 34a-34d and any other network components coupled to one or more of networks 36a-36c may communicate status and control signals between and among each other. Communication links 37a and 37b couple communication networks 36a and 36b, and communication networks 36a and 36c, respectively. In the illustrated embodiment, communication link 37b is a wide area network (WAN) which couples LANs 36a and 36c.

Communication network 36a includes a plurality of segments 40 and nodes 41 that couple endpoints 32a and 32f with IMSs 34a and 34b, gateway 38 and communication networks 36b-36c. Therefore, a user of endpoint 32a is provided with access to endpoints 32b-32f, and IMSs 34a-34d. Nodes 41 may include any combination of network components, gatekeepers, call managers, conference bridges, routers, hubs, switches, gateways, endpoints, or other hardware, software, or embedded logic implementing any number of communication protocols that allow for the exchange of packets in communication system 30.

Although the illustrated embodiment includes three communication networks 36a-36c, the term “communication network” should be interpreted as generally defining any network capable of transmitting audio and/or video telecommunication signals, data, and/or messages, including signals, data or messages transmitted through text chat, instant messaging and e-mail. Any one of networks 36a-36c may be implemented as a local area network (LAN), wide area network (WAN), global distributed network such as the Internet, Intranet, Extranet, or any other form of wireless or wireline communication network. Generally, network 36a provides for the communication of packets, cells, frames, or other portions of information (generally referred to as packets herein) between endpoints 32a-32f. Communication network 36a may include any number and/or combination of segments 40, nodes 41, endpoints 32a-32f, and/or IMSs 34a-34d.

In a particular embodiment, communication network 36a employs communication protocols that allow for the addressing or identification of endpoints, nodes, and/or IMSs coupled to communication network 36a. For example, using Internet Protocol (IP), each of the components coupled together by communication network 36a in communication system 30 may be identified using IP addresses. In this manner, network 36a may support any form and/or combination of point-to-point, multicast, unicast, or other techniques for exchanging media packets among components in communication system 30. Any network components capable of exchanging IM, audio, video, or other data using frames or packets, are included within the scope of the present invention.

Network 36a may be directly coupled to other IP networks including, but not limited to, another LAN or the Internet. Since IP networks share a common method of transmitting data, telecommunication signals may be transmitted between IM and telephony devices located on different, but interconnected, IP networks. In addition to being coupled to other IP networks, communication network 36a may also be coupled to non-IP telecommunication networks through the use of interfaces or components, for example gateway 38. In the illustrated embodiment, communication network 36a is coupled with PSTN 36b through gateway 38. PSTN 36b includes switching stations, central offices, mobile telephone switching offices, pager switching offices, remote terminals, and other related telecommunications equipment that are located throughout the world. To be able to communicate over PSTN 36b, IMS 34d may use a modem which translates between digital information that may be used by IMS 34d and audio signals that may be used in PSTN 36b. IP networks transmit data (including IM, voice and video data) by placing the data in packets and sending each packet individually to the selected destination, along one or more communication paths. Unlike a circuit-switched network (like PSTN 36b), a dedicated circuit is not required for the duration of a call or fax transmission over IP networks.

In particular embodiments, communication system 30 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

It will be recognized by those of ordinary skill in the art that endpoints 32a-32f, IMSs 34a-34d and/or gateway 38 may be any combination of hardware, software, and/or encoded logic that provides communication services to a user. For example, endpoints 32a-32f may include a telephone, a personal computer (PC), a video monitor, an IP phone, a cell phone, a personal digital assistant (PDA) or any other communication hardware, software and/or encoded logic that supports the communication of packets of media (or frames), and in particular that supports IM clients, using communication network 36a. Endpoints 32a-32f may also include unattended or automated systems, gateways, other intermediate components or other devices that can establish media sessions. Although FIG. 1 illustrates a particular number and configuration of endpoints, IMSs, segments, nodes, and gateways, communication system 30 contemplates any number or arrangement of such components for IM communications.

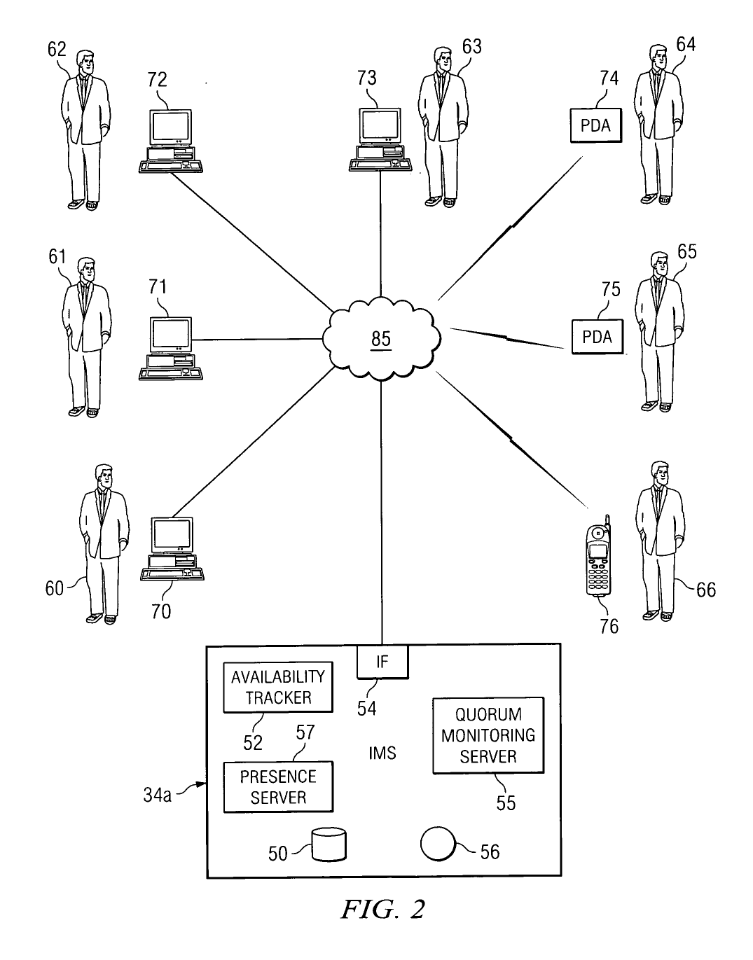

FIG. 2 illustrates IMS 34a in more detail, in accordance with a particular embodiment of the present invention. In the illustrated embodiment, IMS 34a includes a memory module 50, availability tracker 52, interface 54, quorum monitoring server 55, processor 56, and presence server 57. Interface 54 connects IMS 34a to communication network 85. Processor 56 may be a microprocessor, controller, or any other suitable computing device, resource, or combination of hardware, software and/or encoded logic. Processor 56 may work in conjunction with other components of IMS 34a, such as quorum monitoring server 55, to provide the functionality of IMS 34a discussed herein. The functionality discussed herein may also be provided through an endpoint, such as endpoint 70.

Memory module 50 may be any form of volatile or non-volatile memory including, without limitation, magnetic media, optical media, random access memory (RAM), read-only memory (ROM), removable media, or any other suitable local or remote memory component. Memory module 50 may store any suitable information necessary to accomplish the IMS functionality described herein, such as pre-provisioned quorum requirements.

Quorum monitoring server 55 provides IM quorum monitoring functionality to users of IMS 34a as discussed herein. The IM quorum monitoring functionality or quorum monitoring server 55 may generally be referred to as a quorum monitoring service. It may be implemented through, for example, quorum monitoring server 55 working in connection with other IMS components or through any other suitable component. The quorum monitoring service may be based on different types of quorum information, such as: (1) the number and/or classification of invited users, (2) an indication of the number and/or types of users needed, or (3) an indication of the specific users needed. This quorum information may be received from the user setting up the conference or it may be preconfigured with quorum monitoring server 55. The preconfigured quorum information may be the same for all conferences, or it may be based on the type of conference, number of users or any other factor that may be relevant in determining what to use for the quorum information. Quorum monitoring server 55 may comprise any suitable processor, computing device, resource or combination of hardware, software and/or encoded logic and may provide its functionality through processor 56. Some embodiments may utilize a quorum monitoring server that is remotely coupled to an IMS through one or more communication networks.

Availability tracker 52 may monitor or otherwise keep track of the IM availability of users, such as users 60-66. Availability tracker 52 may also be used to keep track of current communication sessions, whether IM, phone or otherwise, in which various users are participating. Availability tracker 52 may be any combination of hardware, software and/or encoded logic. In some cases, availability tracker 52 may work with quorum monitoring server 55, presence server 57 or other components to keep track of current communication sessions of users.

Presence server 57 may be used to detect and monitor the presence of users communicating within a communication system, such as communication system 30 depicted in FIG. 1. In particular embodiments, presence server 57 may be integrated within IMS 34a and may detect information about users 60-66. The information may be used in determining the IM availability of users 60-66. Some embodiments may include a presence server remotely connected to an IMS via a network, such as an IP network. Presence server 57 may provide its functionality through processor 56 and memory 50 of IMS 34a. Additionally, presence server 57 may include a single computer or a group of computers that are capable of detecting the presence and current communication activity of a user at an endpoint associated with the user. Examples of presence servers include presence servers as defined by IETF specifications.

While FIG. 2 depicts computer endpoints 70-73 associated with users 60-63, respectively, PDA endpoints 74 and 75 associated with users 64 and 65, respectively, and cell phone endpoint 76 associated with user 66, IMS 34a may be used with any appropriate number of suitable endpoints, such as those described above with respect to FIG. 1. In the illustrated embodiment, endpoints 70-76 are coupled to each other and to IMS 34a through communication network 85, which may comprise one or more communication networks such as the communication networks described above with respect to FIG. 1.

As an example in operation, user 60 utilizes endpoint 70 to attempt to establish an IM session with users 61-66, where users 61 and 63-65 are currently unavailable. Users 61-66 will generally be referred to as invited IM participants or invitees, though it should be noted that depending on the configuration of IMS 34a, a particular invited IM participant may or may not receive an “invitation.” To establish the IM communication session, user 60 runs an IM client program (e.g., a SameTime application of Cisco Systems, Inc.) from endpoint 70 which, in this example, is a personal computer. The IM client communicates with IMS 34a through interface 54 to log user 60 into IMS 34a. At least part of the login process may involve authenticating user 60 to IMS 34a. Once the IM client has properly logged user 60 into IMS 34a, user 60 can attempt to establish an IM communication session with any other user who is presently logged in and available for IM communication (for purposes of this example all users know the necessary IM contact information of all the other users). User 60 may be informed of the availability of the other users through a graphical user interface that may be part of the IM client program. The other users' availability status may be received from IMS 34a via availability tracker 52 and/or presence server 57.

It may be that user 60 may not currently be able to start an IM session because users 61 and 63-65 are not available. The number of users 61-66 that need to be available before the IM session may begin may vary depending on the situation and the setup of IMS 34a. In the following examples, designed to illustrate some of the possible requirements for beginning an IM session, users 60-66 may generally be identified as “unspecified,” “required,” or “desired.” The labels “unspecified,” “required,” and “desired” are not intended to limit the scope or functionality of the invention but rather are used for the sole purpose of simplifying the explanation. In general “required” users are users within a group of users in which all the users in that group must be available; “desired” users are users within a group of users in which none of the user in that group have to be available; and “unspecified” users are users within a group of users in which some ratio, percentage or specific number of the users in that group are needed to satisfy a quorum requirement.

In the first example assume user 60 is scheduling an IM session among the board of directors for a corporation, and the corporation's by-laws stipulate that a majority of the board members need to be present. The quorum monitoring service may accordingly be pre-provisioned to require at least four board members to be available before starting an IM session. Thus users 60-66 are “unspecified” and IMS 34a may not begin the IM session until at least four of the unspecified users, users 60-66, are available for IM communication. Because in this scenario there are three users currently available, users 60, 62 and 66, the quorum monitoring service may be invoked to monitor users 60-66 to determine when at least four of the users become available.

In the second example the corporation's by-laws may require all the board members to be present at any board meeting. Accordingly, the quorum monitoring service may be pre-provisioned to require all board members to be available before a meeting of the board members may be conducted through IM. In this example, users 60-66 may all be labeled “required.” Thus IMS 34a may wait for all of users 60-66 to be available for IM communication before it determines that the quorum requirements have been satisfied.

The next two examples illustrate conferences in which a single IM session may involve multiple groups of users. For these examples assume user 60 is a patent attorney, users 61-64 are the inventors and users 65 and 66 are other employees of the company (e.g. in-house counsel or president). In the third example further assume that user 60 wants to have an IM session to discuss a patent application. In this example, user 60 may specify that the IM session can not begin until users 61-64 are available for IM communication. Thus, users 60-64 would be “required” while users 65 and 66 would be “desired,” and so IMS 34a may wait for users 60-64 to all be available for IM communication before beginning the IM session. Once users 60-64 are available for IM communication, IMS 34a may also invite or include “desired” users 65 and 66 in the IM session, if users 65 and 66 are, or become, available during the IM session.

In the fourth example assume that user 60 wants to have an IM session to discuss potential licensing options for an invention. In this example, user 60 may specify that the IM session can not begin until users 65 and 66 are available and at least one of the inventors, users 61-64, are available for IM communication. Thus, users 60, 65 and 66 are “required” and users 61-64 are “unspecified.” Accordingly, IMS 34a may wait to start the IM session until all the required users 60, 65 and 66 are available for IM communication, and at least one of the unspecified users 61-64 is available for IM communication.

It should be noted that even though the availability of “desired” users does not impact the start of the conference, IMS 34a may still be monitoring their availability so that they may be invited to or included in the IM session if and when they become available. Similarly, if IMS 34a detects that the requisite number of “unspecified” users is available IMS 34a may still monitor the IM availability of the other “unspecified” users so that IMS 34a may invite them to or include them in the IM session if and when they become available.

A user may be presently unavailable for IM communication for any of a number of reasons. For example, he may not have logged into IMS 34a, or he may be logged into IMS 34a but he may have elected to indicate his status as unavailable, or he may have timed-out, causing his IM client or IMS 34a to mark his status as unavailable even though he is still logged in. Additionally, in particular embodiments availability tracker 52 may consider a user unavailable if the user is already involved in more than a certain number of IM chat sessions, or if the user has sent more than a specific number of IM communications within a particular amount of time. For example, if a user is presently involved in more than five IM chat sessions availability tracker 52 may consider the user unavailable. Similarly, if a user has sent and/or received more than thirty IM communications within the last minute then IMS 34a may consider the user unavailable. The number of IM chat sessions, IM communications and the amount of time may be pre-provisioned so that the criteria used to determine the availability of a user is the same for each conference or it may be set by the user invoking the quorum monitoring service so that the criteria used to determine the availability of a user will change from conference to conference.

By taking advantage of some of the various features that may be present in the functionality contained within IMS 34a or the IM client program running on endpoint 70, user 60 is able to start an IM session with users 61-66 when a requisite quorum of users are available. To accomplish this user 60 may invoke a quorum monitoring service, as enabled by IMS 34a, to monitor the IM availability of users 61-66 and be notified when the quorum requirements are satisfied. In particular embodiments, a different user, for example a secretary of user 60, may invoke the quorum monitoring service. The secretary may do this through, for example, calendaring software, the internet, or his own IM client program. Similarly, user 60 may invoke the quorum monitoring service using applications other than his IM client.

Different embodiments may handle the notification differently. For example, some embodiments may notify only user 60, while some may notify the available users that a quorum has been detected. In particular embodiments, the notice may be an invitation that includes, for example, a softkey that allows a user to join the IM session. Some embodiments may notify the available users that a quorum has been detected by initiating the IM session between the available users. Some embodiments may provide the available users with the topic of the IM session.

There is a wide variety of ways in which a user can submit a quorum monitoring request. For example, in some embodiments the user can submit his request using a “right-click” pop-up menu. In this embodiment, when user 60 logs into IMS 34a his IM client may present him with a buddy list. The buddy list is comprised of users for whom user 60 has entered an IM screen name or address. The buddy list may show the present availability status of the users that comprise the buddy list. For example, user 60's buddy list may show him whether users 61-66 are presently unavailable for IM communication. User 60 may then highlight those users that he wants to include in his IM session and “right-click” somewhere within the highlighted list of users to cause a pop-up menu to appear. One of the options on the menu may be to invoke a quorum monitoring service to monitor the IM availability of the selected users.

In some embodiments all user 60 needs to do to invoke the quorum monitoring service is to select the quorum monitoring feature from the pop-up menu. Other ways user 60 may invoke a quorum monitoring service may include selecting a quorum icon into which user 60 may drag-and-drop desired users, using a webpage, using a calendaring program or using any other device and/or program that connects a user to a quorum monitoring service. In some embodiments, user 60 may be prompted with a request to supply IMS 34a with the type, location and/or device that user 60 wants to use to receive his notification. In some embodiments user 60 may specify additional information that may be used in the determining the quorum requirements. For example, user 60 may specify which of the selected users from his buddy list are required and/or which users are desired.

Furthermore, in particular embodiments, after electing to monitor the IM availability of the group of users, user 60 may be prompted to enter a topic of the IM session. The topic user 60 enters may be used for a variety of purposes, such as inviting the selected users to the IM session or informing the selected users of the upcoming IM session. The topic may be sent to the users when the quorum monitoring service is invoked or as the invitees become available (if they were not available when the service was invoked), or it may be sent once a quorum has been detected or at any other time that may be convenient or practical. The topic may be sent via an IM message that is sent to the available user (and to other users as they become available) and/or via an e-mail message.

Once a quorum monitoring request has been received, the actual quorum monitoring service is invoked. This entails IMS 34a using some combination of quorum monitoring server 55, availability tracker 52, processor 56 and memory 50 to monitor the IM availability of users 60-66. For example, quorum monitoring server 55 could maintain the quorum monitoring services requested by any user connected to IMS 34a. In doing so it may rely on availability information generated by availability tracker 52 to determine who is and is not available. Quorum monitoring server 55 may also use processor 56 to execute any logic quorum monitoring server 55 needs to function including processing information from availability tracker 52. Quorum monitoring server 55 may further utilize memory 50 to store the quorum monitoring requests and any associated quorum requirements.

Additionally, some embodiments may allow user 60 to specify whether he wants IMS 34a to send notifications or invitations to the users whose IM availability he is monitoring or to automatically include them in an IM chat session. In some embodiments IMS 34a may send a notice to an invited IM participant when that particular invited IM participant becomes available for IM communication so that if the user wants to attend the IM session he may attempt to maintain his IM availability. In some embodiments the notice may be sent after the necessary users are available for IM communication so that a notice is not sent for an IM session that does not happen (because, for example, not enough users were available).

It will be recognized by those of ordinary skill in the art that IMS 34a is merely one example configuration of an IMS for using an instant messaging quorum monitoring service in accordance with particular embodiments. IMS 34a may include any number of quorum monitoring servers, interfaces, processors, memory modules and availability trackers to accomplish the functionality and features described herein. For example, although IMS 34a is illustrated and described as including memory module 50, availability tracker 52, interface 54, quorum monitoring server 55, processor 56, and presence server 57 these components and other desired components for performing the above described functionality may be centrally located (local) with respect to one another, or distributed throughout communication system 30. In addition, one or more components of IMS 34a may work together in performing various functionality described herein. Moreover, IMS 34a may work with other network and/or communication components, such as a call manager, to perform the various functionality described herein.

FIG. 3 is a flowchart illustrating a method for providing an instant messaging quorum monitoring service in accordance with a particular embodiment. The method begins at step 310 where a request is received from a first user to monitor the instant messaging availability of a group of users where at least one of the users is currently unavailable. The request may be received by an IMS, an endpoint, or any other device capable of providing a quorum monitoring service. Furthermore, the request may be generated in a variety of ways, for example through the IM client program, a calendaring program, a webpage, or any other device or software that allows a user to enter information for use by a quorum monitoring service. These different ways may be invoked by the user initiating the meeting, or by someone on behalf of the person initiating the meeting, for example a secretary. As mentioned above the quorum monitoring service generally refers to the functionality used in monitoring several users to determine when a quorum of users is available for IM communication. The first user may send his request from his personal computer, PDA or any other appropriate endpoint from which he may be running his IM client program, such as SameTime. The IMS may provide the availability of the users for the IM client to display. This information may be relayed to the user in a variety of ways, for example the IM client may utilize a graphical user interface having a window that displays a unique identifier for the user and an icon showing the IM availability of every user on his buddy list. This allows the first user to quickly and easily determine if the users he wants confer with are available and if not, whether he wants to invoke a quorum monitoring service.

At step 320 a quorum parameter for an IM session is received. The quorum parameter may be received from the first user or it may be preconfigured with the device performing the quorum monitoring service. For example, a corporation may have predetermined guidelines as to the number of shareholders that have to be present to have a shareholder's meeting and thus have preconfigured their IMS to ensure that the predetermined guidelines are met before allowing a shareholder meeting to occur through IM.

The quorum parameter may include any of a number of different requirements that may be fulfilled before a quorum is met. For example, the first user may specifically require that certain users be available, or the first user may only require that a specific number, ratio or percentage of the group of users be available. The first user may also create different categories of users by, for example, requiring a subset, or a percentage of a subset, of the group of users be available while the remaining users may participate if they are available. Similarly, the quorum monitoring service may also be pre-provisioned to provide any type of quorum parameters that may be needed.

At step 330, a topic for the IM chat session is received by, for example, the IMS or quorum monitoring server. Like the quorum parameter, the topic may be received from the first user or it may be predetermined as part of the quorum monitoring service. The topic may be presented to the group of users (or some specified subset thereof) at a variety of different times, such as when the topic is received or when the user becomes available (if the user was not currently available when the topic was received), when or if the user logs in (even though the user may not be currently available), when the quorum parameter is satisfied, or at any other desired time. Furthermore, the topic may be presented to the entire group or to specified users of the group, via e-mail, IM or any other service that can present a user with a topic. Presenting users with the topic in a manner other than IM may cause a user who would not normally logon to the IM server to logon to the IM server so that she can participate in the conference.

At step 340, the quorum monitoring service monitors the instant messaging availability of the group of users to determine when the requirements of the quorum parameter have been fulfilled. The quorum monitoring service may, for example, be run on an IMS similar to IMS 34a of FIG. 2. To determine whether a user is available, the quorum monitoring service may look at more than just whether a user is logged in to an IM service. For example, a user may have logged into his IM session but may have been inactive for a length of time causing the IM client to mark him as unavailable. The user may may have logged in and marked himself as unavailable. The quorum monitoring service may also look at the number of IM chat sessions the user is currently involved in or the number of IM messages the user has recently sent to determine if a user is available. For example, the quorum monitoring service may determine that a user is unavailable if the user is currently involved in more than ten IM chat sessions, or if the user has sent more than 30 IM messages within the last minute. The reason why the second user is unavailable is not important for this step, it is only important that the first user is currently unable to communicate through IM with the user because the user is unavailable.

At step 350 the quorum monitoring service determines that the quorum parameter is satisfied. Even after the quorum parameter has been satisfied the quorum monitoring service may continue to monitor the IM availability of the group of users so that if users become available after the quorum parameter is satisfied they may still be invited or added to the IM chat session.

At step 360 the first user is notified that the quorum parameter has been satisfied. In particular embodiments the first user may be notified by, for example, a pop-up message informing him that the quorum parameter has been satisfied. In some embodiments the first user may, upon receiving the pop-up message, have to initiate the IM chat session manually (e.g. selecting the users, from the group of users, that are currently available). In other embodiments the pop-up message may include an option, such as a softkey, that may allow the first user to initiate the IM chat session with the available users. In some embodiments the quorum monitoring service may notify the first user that the quorum parameter has been satisfied by initiating an IM chat session with the available users as soon as it detects that the quorum participants are available. Accordingly the other available users may automatically be included in the IM chat session. In some embodiments the available user may be prompted, before being included in the IM chat session.

In initiating the IM chat session with the other available users the quorum monitoring service may provide the other users with the topic, as received at step 330. The topic may be included with an option to join the IM session or it may be a means of letting users know that another user is trying to establish an IM session, so that the users can schedule accordingly.

Some of the steps illustrated in FIG. 3 may be combined, modified or deleted where appropriate, and additional steps may also be added to the flowchart. Additionally, steps may be performed in any suitable order without departing from the scope of the invention.

As indicated above, technical advantages of particular embodiments include the ability to detect when a quorum of users is available for communication through an IM chat session. Thus, particular embodiments allow a user, who is waiting for the IM availability of a quorum of users, to conduct other activities without having to continuously check the availability of a group of users to determine if a quorum parameter is satisfied before beginning the IM chat session.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and IMS 34a, these elements may be combined, rearranged or positioned in order to accommodate particular routing architectures or needs. In addition, any of these elements may be provided as separate external components to communication system 30, IMS 34a or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for providing an instant messaging quorum monitoring service, comprising:
receiving a request from a first user to monitor instant messaging availability of a first number of users comprising at least one user who is currently unavailable;
receiving at least one quorum parameter for an instant messaging chat session;
monitoring the instant messaging availability of the first number of users;
determining that the at least one quorum parameter for the instant messaging chat session is satisfied by the instant messaging availability of a second number of users of the first number of users, the second number of users comprising available users; and
notifying the first user that the at least one quorum parameter for the instant messaging chat session is satisfied.

2. The method of claim 1, further comprising initiating an instant messaging chat session between the first user and the available users.

3. The method of claim 1, further comprising inviting the available users to participate in an instant messaging chat session with the first user.

4. The method of claim 1, further comprising:
receiving a topic for the instant messaging chat session from the first user; and
notifying the available users of the topic.

5. The method of claim 4, wherein notifying the available users of the topic comprises notifying the available users of the topic via e-mail.

6. The method of claim 4, wherein notifying the available users of the topic comprises notifying the available users of the topic upon determining that the at least one quorum parameter for the instant messaging chat session is satisfied by the instant messaging availability of a second number of users of the first number of users.

7. The method of claim 1, wherein:
the at least one quorum parameter for the instant messaging chat session comprises a designation of a third number of users of the first number of users as required attendees for the instant messaging chat session; and
determining that the at least one quorum parameter for the instant messaging chat session is satisfied by the instant messaging availability of the second number of users of the first number of users comprises determining that the required attendees for the instant messaging chat session are available via instant messaging.

8. The method of claim 1, further comprising receiving a designation of a fourth number of users of the first number of users as desired attendees for the instant messaging chat session.

9. The method of claim 8, further comprising:
determining that at least one of the desired attendees is available via instant messaging; and
inviting the at least one desired attendee to participate in the instant messaging chat session.

10. The method of claim 1, wherein determining that the at least one quorum parameter for the instant messaging chat session is satisfied by the instant messaging availability of a second number of users of the first number of users comprises determining that each of the second number of users is currently participating in less than a fifth number of instant messaging chat sessions.

11. The method of claim 10, wherein determining that each of the second number of users is currently participating in less than a fifth number of instant messaging chat sessions comprises determining that each of the second number of users has sent less than a sixth number of instant messaging communications within a first period of time.

12. A system for providing an instant messaging quorum monitoring service, comprising:
an interface operable to:
receive a request from a first user to monitor instant messaging availability of a first number of users comprising at least one user who is currently unavailable; and
receive at least one quorum parameter for an instant messaging chat session; and
a processor coupled to the interface and operable to:
monitor the instant messaging availability of the first number of users;
determine that the at least one quorum parameter for the instant messaging chat session is satisfied by the instant messaging availability of a second number of users of the first number of users, the second number of users comprising available users; and
notify the first user that the at least one quorum parameter for the instant messaging chat session is satisfied.

13. The system of claim 12, wherein the processor is further operable to initiate an instant messaging chat session between the first user and the available users.

14. The system of claim 12, wherein the processor is further operable to invite the available users to participate in an instant messaging chat session with the first user.

15. The system of claim 12, wherein:
the interface is further operable to receive a topic for the instant messaging chat session from the first user; and
the processor is further operable to notify the available users of the topic.

16. The system of claim 15, wherein the processor operable to notify the available users of the topic comprises a processor operable to notify the available users of the topic via e-mail.

17. The system of claim 15, wherein the processor operable to notify the available users of the topic comprises a processor operable notify the available users of the topic when the processor determines that the at least one quorum parameter for the instant messaging chat session is satisfied by the instant messaging availability of a second number of users of the first number of users.

18. The system of claim 12, wherein:
the at least one quorum parameter for the instant messaging chat session comprises a designation of a third number of users of the first number of users as required attendees for the instant messaging chat session; and
the processor operable to determine that the at least one quorum parameter for the instant messaging chat session is satisfied by the instant messaging availability of the second number of users of the first number of users comprises a processor operable to determine that the required attendees for the instant messaging chat session are available via instant messaging.

19. The system of claim 12, wherein the interface is further operable to receive a designation of a fourth number of users of the first number of users as desired attendees for the instant messaging chat session.

20. The system of claim 19, wherein the processor is further operable to:
determine that at least one of the desired attendees is available via instant messaging; and
invite the at least one desired attendee to participate in the instant messaging chat session.

21. The system of claim 12, wherein the processor operable to determine that the at least one quorum parameter for the instant messaging chat session is satisfied by the instant messaging availability of a second number of users of the first number of users comprises a processor operable to determine that each of the second number of users is currently participating in less than a fifth number of instant messaging chat sessions.

22. The system of claim 21, wherein the processor operable to determine that each of the second number of users is currently participating in less than a fifth number of instant messaging chat sessions comprises a processor operable to determine that each of the second number of users has sent less than a sixth number of instant messaging communications within a first period of time.

23. Logic embodied in a computer readable medium, the computer readable medium comprising code operable to:
receive a request from a first user to monitor instant messaging availability of a first number of users comprising at least one user who is currently unavailable;
receive at least one quorum parameter for an instant messaging chat session;
monitor the instant messaging availability of the first number of users;
determine that the at least one quorum parameter for the instant messaging chat session is satisfied by the instant messaging availability of a second number of users of the first number of users the second number of users comprising available users; and
notify the first user that the at least one quorum parameter for the instant messaging chat session is satisfied.

24. The medium of claim 23, wherein the code is further operable to initiate an instant messaging chat session between the first user and the available users.

25. The medium of claim 23, wherein the code is further operable to invite the available users to participate in an instant messaging chat session with the first user.

26. The medium of claim 23, wherein the code is further operable to:
receive a topic for the instant messaging chat session from the first user; and
notify the available users of the topic.

27. The medium of claim 26, wherein the code operable to notify the available users of the topic comprises code operable to notify the available users of the topic via e-mail.

28. The medium of claim 26, wherein the code operable to notify the available users of the topic comprises code operable to notify the available users of the topic when it is determined that the at least one quorum parameter for the instant messaging chat session is satisfied by the instant messaging availability of a second number of users of the first number of users.

29. The medium of claim 23, wherein:
the at least one quorum parameter for the instant messaging chat session comprises a designation of a third number of users of the first number of users as required attendees for the instant messaging chat session; and
the code operable to determine that the at least one quorum parameter for the instant messaging chat session is satisfied by the instant messaging availability of the second number of users of the first number of users comprises code operable to determine that the required attendees for the instant messaging chat session are available via instant messaging.

30. The medium of claim 23, wherein the code is further operable to receive a designation of a fourth number of users of the first number of users as desired attendees for the instant messaging chat session.

31. The medium of claim 30, wherein the code is further operable to:
determine that at least one of the desired attendees is available via instant messaging; and
invite the at least one desired attendee to participate in the instant messaging chat session.

32. The medium of claim 23, wherein the code operable to determine that the at least one quorum parameter for the instant messaging chat session is satisfied by the instant messaging availability of a second number of users of the first number of users comprises code operable to determine that each of the second number of users is currently participating in less than a fifth number of instant messaging chat sessions.

33. The medium of claim 32, wherein the code operable to determine that each of the second number of users is currently participating in less than a fifth number of instant messaging chat sessions comprises code operable to determine that each of the second number of users has sent less than a sixth number of instant messaging communications within a first period of time.

34. A system for providing an instant messaging quorum monitoring service, comprising:
means for receiving a request from a first user to monitor instant messaging availability of a first number of users comprising at least one user who is currently unavailable;
means for receiving at least one quorum parameter for an instant messaging chat session;
means for monitoring the instant messaging availability of the first number of users;
means for determining that the at least one quorum parameter for the instant messaging chat session is satisfied by the instant messaging availability of a second number of users of the first number of users the second number of users comprising available users; and
means for notifying the first user that the at least one quorum parameter for the instant messaging chat session is satisfied.
